(19) United States
(12) Patent Application Publication
(10) Pub. No.: US 2023/0173371 A1
(43) Pub. Date: Jun. 8, 2023

(54) VIRTUAL GOLF DEVICE

(71) Applicant: SGM CO., LTD., Seongnam-si Gyeonggi-do (KR)

(72) Inventors: Ui Bum LEE, Seongnam-si Gyeonggi-do (KR); Kap Su KIM, Seoul (KR)

(21) Appl. No.: 17/544,917

(22) Filed: Dec. 7, 2021

(51) Int. Cl. A63B 71/06; A63B 24/00

(52) U.S. Cl. CPC A63B 71/0622; A63B 24/0021; A63B 2071/0638; A63B 2071/0691; A63B 2102/32

(57) ABSTRACT

The present inventive concept relates to a virtual golf device comprising a display part showing a virtual golf course and a virtual golf ball, and a calculation part calculating a movement of the virtual golf ball corresponding to a real golf ball on the virtual golf course when a user hits the real golf ball. The display part provides an information section showing information related to a green region with a target point. If a location of the virtual golf ball on the virtual golf course before the user hits the real golf ball is named a first location, a location of the target point is named a second location and a direction from the first location to the second location is named a first direction, the information section shows a distance between the second location and an intersection point where an imaginary line passing the target point and having a second direction perpendicular to the first direction meets a border of the green region.

### TECHNICAL FIELD

The present disclosure relates to a virtual golf device that can provide various information about golf play.

### BACKGROUND ART

Simulation devices for enjoying sports games without having to go to a field have been developed by using image and computer simulation technology so that virtual indoor sports games such as golf or baseball have come into wide use. In particular, the popularity of screen golf where users can enjoy golf play using a virtual golf simulation device is increasing as the golf population increases. Since images of a golf course are displayed through a screen in the screen golf, it can give the feeling of playing a real golf game outside and time and money can be saved in comparison with the play at an outdoor field. As a result, the screen golf is very popular among busy modern people who have difficulty in playing a real outdoor golf due to time or economic reasons, etc.

However, as the number of screen golf users increases, users’ expectations are increasing. Therefore, it is necessary for the screen golf to provide users with the feeling of really playing sports games outside and various contents using advanced technology that are difficult to be provided in actual golf in order to improve users’ convenience.

### DISCLOSURE

### Technical Problem

In order to solve the above-mentioned problems, the present inventive concept provides a virtual golf device providing various information about a golf course in easily perceptible form to make users easily and accurately obtain various information about golf play.

The other objects of the present inventive concept will be clearly understood with reference to the following detailed description and the accompanying drawings.

### Technical Solution

In order to the above-mentioned objects, a virtual golf device according to an embodiment of the present inventive concept comprises a display part showing a virtual golf course and a virtual golf ball, and a calculation part calculating a movement of the virtual golf ball corresponding to a real golf ball on the virtual golf course when a user hits the real golf ball. In this virtual golf device, the display part provides an information section showing information related to a green region with a target point. If a location of the virtual golf ball on the virtual golf course before the user hits the real golf ball is named a first location, a location of the target point is named a second location and a direction from the first location to the second location is named a first direction, the information section shows a distance between the second location and an intersection point where an imaginary line passing the target point and having a second direction perpendicular to the first direction meets a border of the green region.

In the virtual golf device, the imaginary line meets the border of the green region at a plurality of intersection points, and the information section shows all distances between the second location and the intersection points.

In the virtual golf device, the imaginary line meets the border of the green region and at a plurality of intersection points, and the information section shows a shortest distance of all distances between the second location and the intersection points.

A virtual golf device according to another embodiment of the present inventive concept comprises a display part showing a virtual golf course and a virtual golf ball, and a calculation part calculating a movement of the virtual golf ball corresponding to a real golf ball on the virtual golf course when a user hits the real golf ball. In this virtual golf device, the display part provides an information section showing information related to an interest region comprising at least one region of a fairway region, a rough region, a bunker region, a water hazard region and an OB region. If a location of the virtual golf ball on the virtual golf course before the user hits the real golf ball is named a first location and a location of a target point on the virtual golf course is named a second location, the information section shows a distance between the first location and an intersection point where an imaginary line staring from the first location and having a direction from the first location to the second location meets a border of the interest region.

In the virtual golf device, the of imaginary line meets the border of the interest region at a plurality of intersection points, and the information section shows all distances between the first location and the intersection points.

A virtual golf device according to another embodiment of the present inventive concept comprises a display part showing a virtual golf course and a virtual golf ball, and a calculation part calculating a movement of the virtual golf ball corresponding to a real golf ball on the virtual golf course when a user hits the real golf ball. In this virtual golf device, the display part provides an information section showing information related to an interest region, and the information section also shows additional information calculated from play records of the user and associated with the information related to the interest region.

### Advantageous Effects

According to a virtual golf device of the present inventive concept, users can easily and accurately obtain various information about golf play.

### BRIEF DESCRIPTION OF THE DRAWINGS

FIG. 1 shows a schematic structure of a virtual golf device according to an embodiment of the present inventive concept.

FIG. 2 shows a relationship among main components of the virtual golf device of FIG. 1.

FIGS. 3 to 6 are views for showing concrete examples of various information that can be displayed in the information section of the virtual golf device of FIG. 1.

FIG. 7 is a view showing one example of the structure of the storage part of the virtual golf device of FIG. 2.

FIG. 8 is a view showing a specific example for displaying additional information in the information section.

FIGS. 9 to 11 show a schematic structure of a virtual golf device according to another embodiment of the present inventive concept.

### DETAILED DESCRIPTION

Hereinafter, a detailed description will be given of the present inventive concept with reference to the following embodiments. The purposes, features, and advantages of the present inventive concept will be easily understood through the following embodiments. The present inventive concept is not limited to such embodiments but may be modified in other forms. The embodiments to be described below are nothing but the ones provided to bring the disclosure of the present inventive concept to perfection and assist those skilled in the art to completely understand the present inventive concept. Therefore, the following embodiments are not to be construed as limiting the present inventive concept.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. It will be understood that when an element is referred to as being “on” another element, it can be directly on the other element or intervening elements may be present therebetween.

The size of the element or the relative sizes between elements in the drawings may be shown to be exaggerated for more clear understanding of the present inventive concept. In addition, the shape of the elements shown in the drawings may be somewhat changed by variation of the manufacturing process or the like. Accordingly, the embodiments disclosed herein are not to be limited to the shapes shown in the drawings unless otherwise stated, and it is to be understood to include a certain amount of variation.

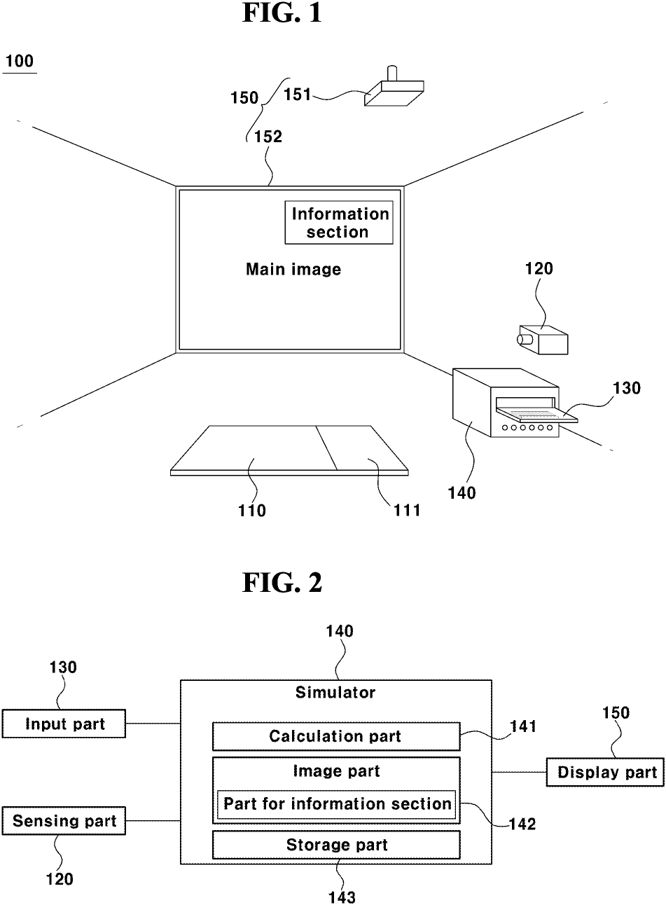

FIG. 1 shows a schematic structure of a virtual golf device according to an embodiment of the present inventive concept, and

FIG. 2 shows a relationship among main components of the virtual golf device of FIG. 1.

Referring to FIGS. 1 and 2, the virtual golf device 100 comprises a hitting plate 110, a sensing part 120, an input part 130, a simulator 140 and a display part 150.

The hitting plate 110 falls under a hitting zone where a golf ball for hitting is located. There is a hitting mat 111 at the hitting plate 110. A golf ball is given to a user by a means for supplying a golf ball at the hitting mat 111.

The sensing part 120 senses the movement of the golf ball hit by the user to detect overall state information about the hit golf ball. As the sensing part 120, a sensing means such as a camera or a sensor capable of sensing the movement of the golf ball can be used. Various sensing methods such as image sensing, light-emitting/light-receiving sensing, laser sensing and the like may be applied to the sensing means, and the state information of a golf ball hit by a user can be detected through such the various sensing methods. The camera or the sensor may be used alone or used together, and only one sensing unit may be used or several sensing units may be used if circumstances need.

The input part 130 receives information from the user. As the input part 130, a keyboard or a mouse can be used. In the screen golf, the information input by the user is needed for various cases. For example, when the user inputs his/her ID or password or selects a golf course or a play difficulty level, the user needs to input the related information. The input part 130 is needed for this object.

The simulator 140 includes a calculation part 141, an image part 142 and a storage part 143. The calculation part 141 receives the state information about the hit golf ball from the sensing part 120 when the user hits the golf ball, and then computes the trajectory of the golf ball based on the received information. The image part 142 generates a golf-related image to be shown to the user and sends it to the display part 150. The image generated by the image part 142 includes a main image and a sub image. The golf course or the golf ball can be shown in the main image, and various additional information can be shown in the sub image. For example, a mini-map representing the reduced entire golf course can be displayed as the sub image. According to the present inventive concept, an information section providing various play information to the user can be shown in the sub image, and the image part 142 may be provided with a separate part for the information section image. The storage part 143 stores various data necessary for the operation of the calculation part 141 and the image part 142.

The display part 150 includes a projector 151 and a screen 152. The projector 151 gives the golf-related image to the screen 152, and the screen 152 displays the given image to provide it to the user. Hereinafter, some objects displayed on the screen 152 may be expressed by using the term ‘virtual’. This means that the objects do not exist in the real world and are displayed on the screen 152. For example, ‘virtual golf course’ means a golf course displayed on the screen 152 and ‘virtual golf ball’ means a golf ball displayed on the screen 152.

The virtual golf device 100 may be installed on a sealed room and the user can play the screen golf in the room by using the virtual golf device 100. When the user plays the screen golf, the virtual golf device 100 operates as follows.

First, when the user hits a golf ball, the sensing part 120 detects a physical state such as a speed or a moving direction of the golf ball hit by the user. The information sensed by the sensing part 120 is transmitted to the simulator 140, and the calculation part 141 of the simulator 140 computes the trajectory of the golf ball based on the transmitted information under the assumption that the user hits the golf ball at an actual outdoor golf course. The image part 142 generates an image of the golf ball moving along the calculated trajectory, and the display part 150 displays the generated image to provide it to the user.

The golf course for the screen golf play may be modeled after an actual golf course that really exist or may be an arbitrarily created golf course that does not exist. The golf course where the user is playing is displayed on the screen 152 as the main image. When the user hits the golf ball and the trajectory of the hit golf ball is calculated, an image where the golf ball moves along the calculated trajectory on the golf course and stops at a predetermined point is displayed on the screen 152 as the main image. Since most users are interested in the golf ball, the area mainly displayed on the screen 152 in the golf course is the area where the golf ball is located and the area near the golf ball. The mainly displayed area changes according to the movement of the golf ball. However, in order to get a good score, it is necessary to grasp not only the area where the current golf ball is located but also additional information such as the position of the hole cup which is the final target point and the distance between the golf ball and the hole cup, etc. What is displayed on the screen 152 as the main image is not sufficient to provide the additional information. According to the present inventive concept, the additional information can be provided to the user through an information section displayed on the screen 152 as the sub image.

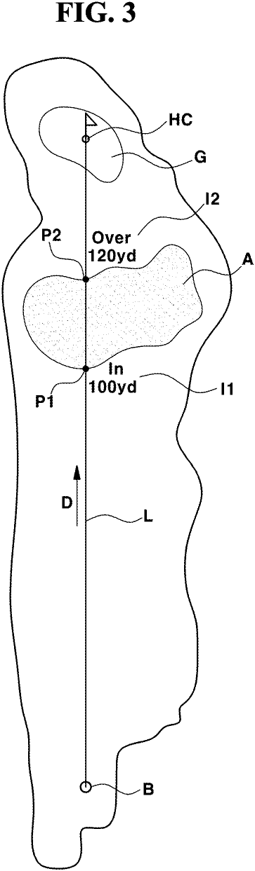

FIGS. 3 to 6 are views for showing concrete examples of various information that can be displayed in the information section of the virtual golf device of FIG. 1.

Referring to FIG. 3, a mini-map for a virtual golf course may be provided in the information section. The mini-map was widely used for the convenience of gamers in computer games. Recently, the mini-map has been used in various fields as well as in computer games. In the screen golf, the mini-map shows the entire area of each hole of the golf course in a reduced form.

In the screen golf play, a user hits a golf ball until putting the golf ball into the hole cup, and the play score is decided by the number of hitting the golf ball until putting the golf ball into the hole cup. A golf game consists of 18 golf courses (18 holes) and the number of hitting the golf ball is added up for 18 golf courses. The golf course composing each hole includes various areas such as ‘Teeing Ground’, ‘Green’ , ‘Through the Green (between the teeing ground and the green)’ . Since the distance from the tee shot position of the teeing ground to the hole cup located at the green is quite far, the screen mainly displays a limited area around the golf ball. Therefore, the user has a difficulty in knowing where the golf ball is located in the entire golf course, and this can be solved by providing the mini-map showing a reduced golf course.

The mini-map can be of great help to the user’s play, but the mini-map alone may not be sufficient because various information is required for the screen golf play. The information section can provide a variety of useful information for the screen golf play to the user along with the mini-map. For example, the information section can provide the distance information from the current position of user’s golf ball to the hole cup and can also provide various additional information necessary for the user. Hereinafter, some examples of information that can be provided by the information section will be described.

In a situation shown in the mini-map of FIG. 3, the virtual golf ball (B) corresponding to the real golf ball to be hit by the user is located at a predetermined position of a certain virtual golf course and is far away from the hole cup (HC) located at the green area (G). An interest region (A) that the user is likely to take interest in is disposed between the virtual golf ball (B) and the hole cup (HC). For example, the interest region (A) may be a dangerous area that is a hindrance to user’s play such as a rough area, a bunker area, a water hazard, or the like. For another example, the interest region (A) may be an OB area outside the golf course or a green area where the hole cup (HC) is located. That is, the interest region (A) may be any area that the user may be interested in whether it is disadvantageous or advantageous to the user.

If the interest region (A) is a bunker, the user generally wants to avoid hitting the golf ball in the bunker since it is not easy to get out of the bunker. In order to avoid the bunker, the information related to the bunker is very important to the user. For this purpose, the information correlated between the current virtual golf ball (B) and the bunker (interest region (A) ) is provided. Concretely, a line (L) connecting the virtual golf ball (B) and the hole cup (HC) is displayed in the mini-map through the information section. This line (L) follows a predetermined direction (D) and passes through the bunker. When intersection points where the line (L) meets a border of the bunker are named a first point (P1) and a second point (P2), the information section shows a first distance (I1) between the virtual golf ball (B) and the first point (P1), and a second distance (I2) between the virtual golf ball (B) and the second point (P2). The distance can be expressed in yards (yd) or meters (m). Or the distance can be expressed as only numbers without a unit if the user knows what unit it is. Since the distances (I1, I2) are shown in this way, the user can adjust the strength of hitting the golf ball so that the possibility of landing the golf ball in front of the bunker or over the bunker can be increased. Since the first and second distances (I1,I2) are more important to the user than the line (L), it is possible to display only the distances (I1,I2) without the line (L).

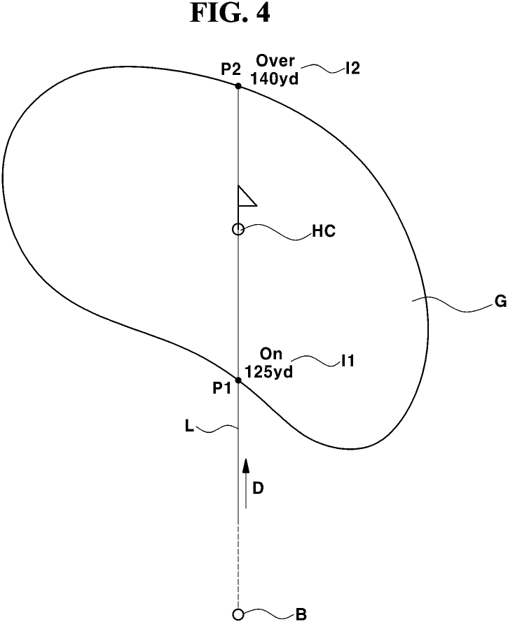

Referring to FIG. 4, since the final goal in golf play is to put a golf ball into the hole cup (HC) and the hole cup (HC) is located at the green area (G) , the green area (G) may be the user’s interest region. Accordingly, the mini-map for the green area (G) and the information related to the green area (G) are displayed in the information section. For example, when the virtual golf ball (B) is apart from the green area (G) where the hole cup (HC) is located, a line (L) starting from the current virtual golf ball (B) and having a direction (D) from the virtual golf ball (B) to the hole cup (HC) is displayed in the mini-map through the information section. In addition, when this line (L) meets a border of the green area (G) and the intersection points are named a first point (P1) and a second point (P2), the information section shows a first distance (I1) from the virtual golf ball (B) to the first point (P1) and a second distance (I2) from the virtual golf ball (B) to the second point (P2). Since the first and second distances (I1,I2) are shown in this way, the user can determine with what strength he/she should hit the golf ball in order for the virtual golf ball to reach the green area (G). Since the first and second distances (I1,I2) are more important to the user than the line (L), it is possible to display only the distances (I1,I2) without the line (L).

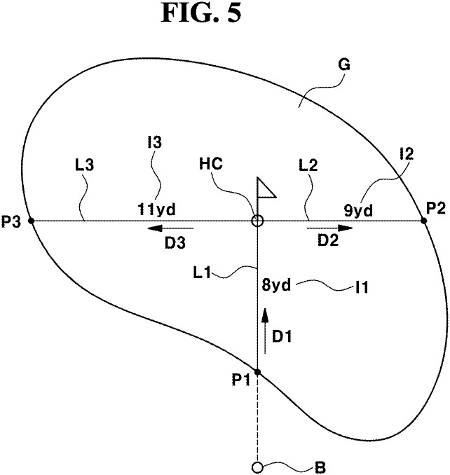

Referring to FIG. 5, in order to provide more detailed information on the green area (G), the distance from the border of the green area (G) to the hole cup (HC) is displayed. Concretely, a line connecting the current virtual golf ball (B) and the hole cup (HC) is displayed. This line follows a first direction (D1) from the virtual golf ball (B) to the hole cup (HC), and meets a border of the green area (G). When the intersection where the line meets the border of the green area (G) is named a first point (P1) and when a line connecting the first point (P1) and the hole cup (HC) is named a first line (L1), the information section shows a length of the first line (L1) (a first distance (I1) ). In addition, a second line (L2) having a second direction (D2) perpendicular to the first direction (D1) and a third line (L3) having a third direction (D3) opposite to the second direction (D2) are shown in the mini-map through the information section. When the second line (L2) meets the border of the green area (G) and the intersection is named a second point (P2), the information section shows a second distance (I2) between the hole cup (HC) and the second point (P2). When the third line (L3) meets the border of the green area (G) and the intersection is named a third point (P3), the information section also shows a third distance (13) between the hole cup (HC) and the third point (P3). All of the first to third lines (L1, L2, L3) and the first to third distances (I1,I2, I3) are not essential, and it is possible to display at least one of them. For example, it is possible to display the second line (L2) shorter than the third line (L3) and the second distance (I2) without the third line (L3) and third distance (I3). Since the first to third distances (I1,I2, I3)are more important to the user than the first to third lines (L1, L2, L3), it is possible to display only the distances (I1,I2, I3)without the lines (L1, L2, L3). By the information section, the user can know the green information and utilize it when hitting the golf ball in front of the green area (G) or putting the golf ball in the green area (G) .

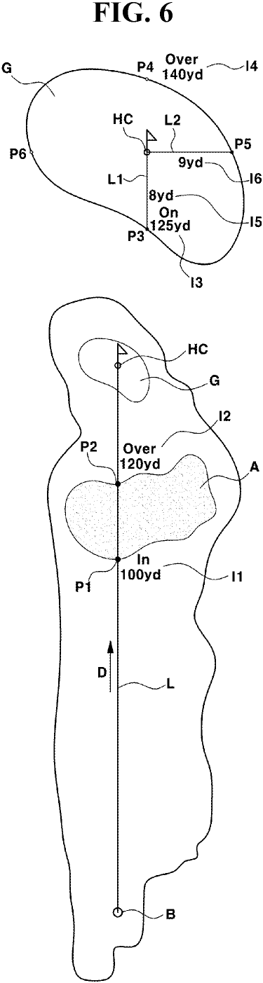

Referring to FIG. 6, in the information section, some or all of the information shown in FIGS. 3, 4, 5 can be combined and displayed together. Concretely, a mini-map of a virtual golf course is shown through the information section. In addition, a line (L) connecting the virtual golf ball (B) and the hole cup (HC) is displayed. This line (L) follows a predetermined direction (D) and passes through an interest region (A) (for example, a bunker region). When intersection points where the line (L) meets a border of the interest region (A) are named a first point (P1) and a second point (P2), the information section shows a first distance (I1) between the virtual golf ball (B) and the first point (P1), and a second distance (I2) between the virtual golf ball (B) and the second point (P2). The first distance (I1) represents the minimum path where the virtual golf ball (B) reaches the interest region (A) when the virtual golf ball (B) is hit toward the hole cup. The second distance I2 represents the minimum path where the virtual golf ball (B) flies beyond the interest region (A) when the virtual golf ball (B) is hit toward the hole cup.

In the information section according to this embodiment, a separate mini-map of the green area (G) is displayed. When it is assumed that the line (L) of the direction (D) passes through the green area (G), a third point (P3) and a fourth point (P4) representing intersection points where the line (L) meets the border of the green area (G) are displayed in the separate mini-map. In addition, a third distance (I3) from the virtual golf ball (B) to the third point (P3) is displayed, and a fourth (I4) from the virtual golf ball (B) to the fourth point (P4) is displayed. When a line connecting the third point (P3) and the hole cup (HC) is named a first line (L1) and a line perpendicular to the first line (L1) is named a second line (L2), the first and second lines (L1, L2) are displayed. In addition, a fifth distance (I5) from the third point (P3) to the hole cup (HC) and a sixth distance (I6) from the hole cup (HC) to the fifth point (P5) are displayed. When a virtual line perpendicular to the first line (L1) and opposite to the second line (L2) is assumed, this virtual line meets the border of the green area (G). When the intersection of the virtual line and the green area (G) is named a sixth point (P6), the distance from the hole cup (HC) to the sixth point (P6) is longer than the sixth length (16). According to the present embodiment, the information section does not provide the distance from the hole cup (HC) to the sixth point (P6) and provides only the distance from the hole cup (HC) to the fifth point (P5) since it is considered that the latter is more important to the user than the former.

Since various distance information is provided in this way, the user can easily establish a strategy for avoiding the interest region (A) and/or a strategy for safely entering the green area (G) by appropriately adjusting the hitting strength, direction, etc.

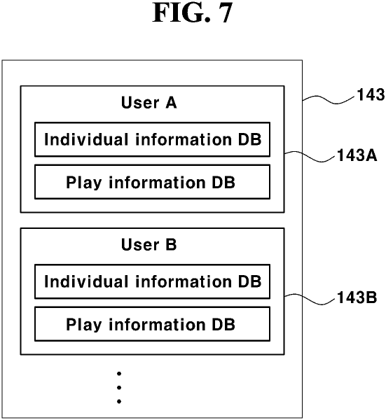

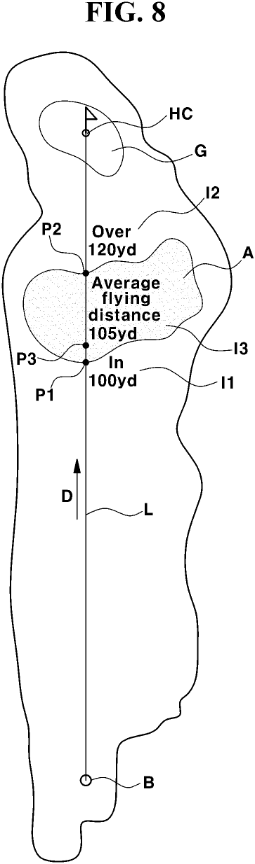

Meanwhile, when providing various play information through the information section, useful additional information can be provided to the user by associating the user’s play records with the play information related to the interest region. Hereinafter, an example of the additional information will be explained with reference to FIGS. 7 and 8.

FIG. 7 is a view showing one example of the structure of the storage part of the virtual golf device of FIG. 2, and FIG. 8 is a view showing a specific example for displaying additional information in the information section.

Referring to FIG. 7, the storage part 143 has a plurality of storage sections that are divided for a plurality of users. For example, if there are different users A and B, the storage part 143 is divided into a storage section 143A for user A and a storage section 143B for user B. The storage section for each user includes a user’s individual information DB, a user’s play information DB, and the like. The user’s individual information DB relates to the user’s personal information. If a login system is applied to the screen golf service, the screen service is available after the user’s login and the user’s personal information can be used in the login process. The user’s play information DB relates to the user’s play records. For example, the user’s play information DB can include the play history information what the user has played in the past. In addition, the user’s play information DB can include the play records calculated from the play history information such as the average number of strokes, the average flying distance, the rate of landing the golf ball on fairway, the green accuracy, the average number of putts, etc.

The user information stored in the storage part 143 may be combined with the golf course information provided through the information section. Concretely, the information section can provide additional information about the expectation of the hit result that can be obtained based on the user’s play information DB, and this additional information can be combined with the information related to the interest region or the green region described above.

For example, as shown in FIG. 8, when a bunker (A) that is one of the interest regions is located between the virtual golf ball (B) and the green area (G) , a line (L) connecting the current virtual golf ball (B) and the hole cup (HC) is displayed in the mini-map through the information section. When this line (L) meets a border of the bunker (A) at a first point (P1) and a second point (P2), the information section shows a first distance (I1) from the virtual golf ball (B) to the first point (P1) and a second distance (I2) from the virtual golf ball (B) to the first point (P2), and also shows the prediction of the hit result obtained based on the user’s play information DB. Concretely, if the first distance (I1) is 100 yd, the second distance (I2) is 120 yd and the user’s average flying distance on an iron shot is 105 yd in a situation where the iron shot is required, a position where the virtual golf ball (B) is expected to land based on the user’s play information such as the average flying distance is shown by the information section. In addition, when the position by prediction is named a third point (P3) and the distance between the virtual golf ball (B) and the third point (P3) is named a third distance (I3), the information section shows the third distance (I3). As a result, the user can establish the strategy for hitting the golf ball at the current situation. That is, if the average flying distance is 105 yd and thus the position by prediction is closer to the first point (P1) than the second point (P2), the user can establish the strategy to hit the golf ball by a swing of strength slightly weaker than a usual swing to land the golf ball before the bunker. If the average flying distance is 115 yd and the position by prediction is closer to the second point (P2) than the first point (P1), the user can establish a strategy to hit the golf ball by a swing of strength slightly stronger than a usual swing to land the golf ball over the bunker.

Regarding the prediction of the hit result in the information section, an example of using the average flying distance of the user is described above, but it is not limited to the average flying distance. As another example, an area where the user’s golf ball is likely to land may be provided by utilizing an average flying distance and a standard deviation based on the user’s past records. Alternatively, the probability that the hit golf ball will land on or deviate from an interest region (such as a bunker or a green area) may be provided through the information section.

By associating the information on the golf course with the user record information in this way, additional golf play information useful to the user’s shot strategy can be provided.

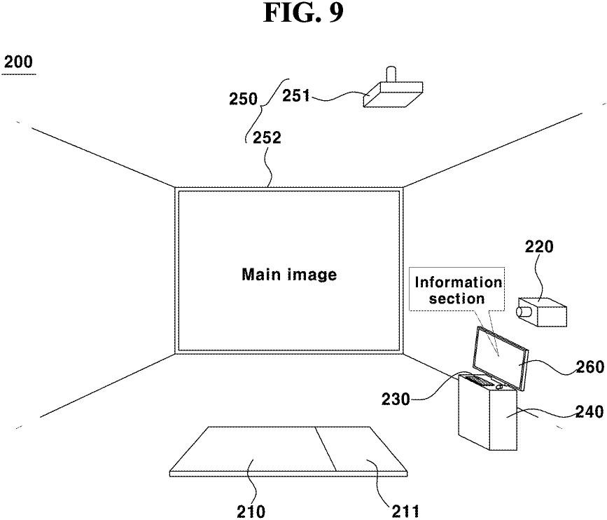

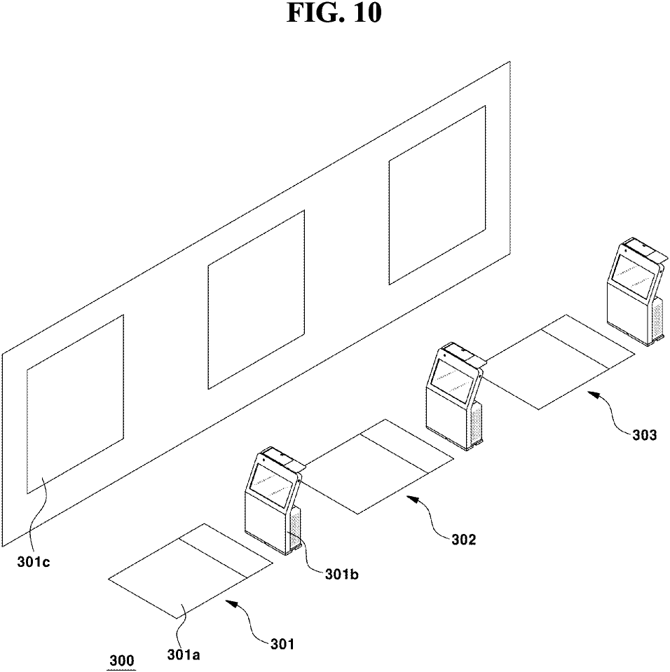

FIGS. 9 to 11 show a schematic structure of a virtual golf device according to another embodiment of the present inventive concept.

Referring to FIG. 9, the virtual golf device 200 according to this embodiment comprises a hitting plate 210, a sensing part 220, an input part 230, a simulator 240, a display part 250 and a kiosk 260.

In the hitting plate 210, there is a hitting mat 211 where a golf ball to be hit is placed. The user hits the golf ball placed on the hitting mat 211. The sensing part 220 detects the physical state of the golf ball hit by the user to deliver it to the simulator 240. The input part 230 includes a keyboard or a mouse that can receive the information input by the user. The simulator 240 receives the information detected by the sensing part 220 to calculate the trajectory of the golf ball based on the received information, generates images in which the golf ball moves along the calculated trajectory and delivers them to the display part 250. The display part 250 includes a projector 251 and a screen 252. The projector 251 gives the images generated by the simulator 240 to the screen 252, and the screen 252 displays the given images to provide them to the user. The kiosk 260 represents a small display and may be one of LCD (Liquid Crystal Display), LED (Light Emitting Diode), OLED (Organic Light Emitting Diode), FED (Field Emission Display), PDP (Plasma Display Panel), flexible display (Flexible Display), etc. The virtual golf device 200 according to this embodiment has a plurality of display apparatus such as the screen 252 and the kiosk 260 that can display images. In this case, the screen 252 can serve as a main display showing main images about the virtual golf ball and/or the virtual golf course, and the kiosk 260 can serve as an auxiliary display showing sub images about additional information. For example, the information provided through the information section described above may be displayed on the kiosk 260. According to the present embodiment, since the kiosk 260 serving as the auxiliary display is separately provided, various images and information can be dynamically provided to users.

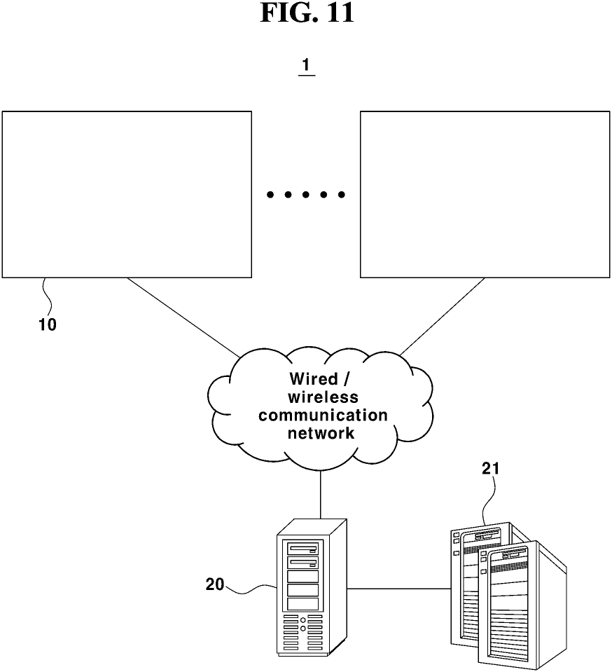

Referring to FIG. 10, the virtual golf device 300 according to the present embodiment includes a plurality of practice booths 301, 302, 303. Each practice booth (301, 302, 303) has the same structure. For example, the first practice booth 301 is equipped with a hitting plate 301a, a simulator 301b with a kiosk, a screen 301c, etc., and the other practice booths 302 and 303 are also equipped with the same components. Although not shown in FIG. 10, each of the practice booths 301, 302, 303 may further include other apparatus including a camera for detecting the movement of a golf ball. The virtual golf device 300 according to the present embodiment can be used by one user or a plurality of users playing or practicing golf. In the virtual golf device 300 according to the present embodiment, various information can be provided to users through the information section described above. The information section can be displayed on at least one of the screen 301c and the kiosk.

Referring to FIG. 11, the virtual golf device 1 according to the present embodiment comprises a plurality of screen golf places 10 and a server unit 20. There is a screen golf device for screen golf play in each of the screen golf places 10, and this screen golf device may have the same or similar structure to the virtual golf device described above with reference to FIGS. 1 to 10. The screen golf device is connected to the server unit 20 through a wired/wireless communication network. The screen golf device serves as a service providing part that provides a screen golf service to a user after the login of the user. The server unit 20 may be a central server used by a service provider having a plurality of screen golf devices to manage the plurality of screen golf devices. A user needs to log in in order to receive the screen golf service. When a user logs in, the server unit 20 checks the user’s identity and determines whether to approve the login. The server unit 20 includes a storage unit 21 that stores individual information necessary for checking the identity of the user. The storage unit 21 also stores the user’s play record information. The storage unit 21 may have the same or similar structure to the storage part described above with reference to FIG. 7. For example, the storage unit 21 may have a plurality of storage sections that are divided for a plurality of users, and the storage section for each user may include a user’s individual information DB, a user’s play information DB, and the like.

Like the virtual golf device described above with reference to FIGS. 1 to 10, this screen golf device installed at each of the screen golf places 10 can display an information section on the screen to provide various information useful for a user’s golf play. The information stored in the storage unit 21 may be used to display the information section. Since the storage unit 21 of the server unit 20 is connected to a plurality of screen golf places 10 via a wired/wireless communication network, the screen golf device in each of the screen golf courses 10 can use the information of the storage unit 21 without separately storing it.

Although the embodiments of the present inventive concept have been disclosed for illustrative purposes, those skilled in the art will appreciate that the present inventive concept may be embodied in other specific ways without changing the technical spirit or essential features thereof. Therefore, the embodiments disclosed in the present inventive concept are not restrictive but are illustrative. The scope of the present inventive concept is given by the claims, rather than the specification, and also contains all modifications within the meaning and range equivalent to the claims.

1. A virtual golf device comprising:
a display part showing a virtual golf course and a virtual golf ball; and
a calculation part calculating a movement of the virtual golf ball corresponding to a real golf ball on the virtual golf course when a user hits the real golf ball,
wherein the display part provides an information section showing information related to a green region with a target point, and
if a location of the virtual golf ball on the virtual golf course before the user hits the real golf ball is named a first location, a location of the target point is named a second location and a direction from the first location to the second location is named a first direction, the information section shows a distance between the second location and an intersection point where an imaginary line passing the target point and having a second direction perpendicular to the first direction meets a border of the green region.

2. The virtual golf device of claim 1, wherein the imaginary line meets the border of the green region at a plurality of intersection points, and the information section shows all distances between the second location and the intersection points.

3. The virtual golf device of claim 1, wherein the imaginary line meets the border of the green region and at a plurality of intersection points, and the information section shows a shortest distance of all distances between the second location and the intersection points.

4. A virtual golf device comprising:
a display part showing a virtual golf course and a virtual golf ball; and
a calculation part calculating a movement of the virtual golf ball corresponding to a real golf ball on the virtual golf course when a user hits the real golf ball,
wherein the display part provides an information section showing information related to an interest region comprising at least one region of a fairway region, a rough region, a bunker region, a water hazard region and an OB region, and
if a location of the virtual golf ball on the virtual golf course before the user hits the real golf ball is named a first location and a location of a target point on the virtual golf course is named a second location, the information section shows a distance between the first location and an intersection point where an imaginary line staring from the first location and having a direction from the first location to the second location meets a border of the interest region.

5. The virtual golf device of claim 4, wherein the of imaginary line meets the border of the interest region at a plurality of intersection points, and the information section shows all distances between the first location and the intersection points.

6. A virtual golf device comprising:
a display part showing a virtual golf course and a virtual golf ball; and
a calculation part calculating a movement of the virtual golf ball corresponding to a real golf ball on the virtual golf course when a user hits the real golf ball,
wherein the display part provides an information section showing information related to an interest region, and the information section also shows additional information calculated from play records of the user and associated with the information related to the interest region.
